(19) United States
(12) Patent Application Publication
(10) Pub. No.: US 2024/0276387 A1
(43) Pub. Date: Aug. 15, 2024

(54) METHOD AND NETWORK NODE FOR UPLINK POWER CONTROL IN WIRELESS COMMUNICATION NETWORKS

(71) Applicant: Telefonaktiebolaget LM Ericsson (publ), Stockholm (SE)

(72) Inventors: Yanpeng YANG, Järfälla (SE); Ying SUN, Täby (SE); Ali YAVER, Sollentuna (SE)

(73) Assignee: Telefonaktiebolaget LM Ericsson (publ), Stockholm (SE)

(21) Appl. No.: 18/568,763

(22) PCT Filed: Jun. 11, 2021
(86) PCT No.: PCT/SE2021/050570

§ 371 Date: Dec. 8, 2023

(51) Int. Cl. H04W 52/14; H04L 1/00; H04W 52/24; H04W 52/36

(52) U.S. Cl. CPC H04W 52/146; H04W 52/24; H04W 52/367; H04L 1/0003

(57) ABSTRACT

Disclosed is a method for uplink, UL, power control performed by a network node (130) of a wireless communication network (100). The method comprises determining, for a User Equipment, UE, a UE-specific Signal to Interference and Noise Ratio, SINR, link adaption target, SINRLA, based on UE-specific Quality of Service, QoS, information for the UE, determining a power target, P0, for the UE, based on the UE-specific SINRLA, and on an estimated interference for UL signals at the network node, and sending information on the determined P0 to the UE, so that the UE can transmit packets in UL with a transmission power based on the determined P0.

### TECHNICAL FIELD

The present disclosure relates generally to methods and network nodes for uplink power control in a wireless communication network. More specifically, the present disclosure relates to determining a power target, P0, for a UE connected to a network node, wherein information on the power target P0 can be sent to the UE so that the UE can transmit in uplink (UL) with a power based on the determined power target P0. The present disclosure further relates to computer programs and carriers corresponding to the above methods and network nodes.

### BACKGROUND

In the ever-increasing demand on wireless communication services, it has been observed that wireless communication devices, aka wireless devices, aka User Equipment (UE) have different needs when it comes to different characteristics, such as latency, data rates, reliability, etc. For this reason, the 5^{th} Generation (5G) wireless communication technology such as New Radio (NR) has introduced different service categories, or use cases, adapted for different groups of wireless devices with different needs. Examples of such service categories are: Ultra reliable and low latency communications (URLLC) that cater for providing multiple advanced services for low latency-sensitive connected devices, such as factory automation, autonomous driving, the industrial Internet and smart grid or robotic surgeries; Enhanced Mobile Broadband (eMBB) that will supply high bandwidth internet access for wireless connectivity, large-scale video streaming, and virtual reality; and Massive Machine Type Communication (MMTC) that supports Internet access for sensing, metering, and monitoring devices.

URLLC services are intended to handle a variety of new demanding wireless use cases. Such use cases appear in the automotive safety field, in factory automation, as well as when augmented and virtual reality functionality with tactile feedback is run over new radio (NR). Such use cases typically have stringent latency requirements reaching 1 ms figures and the reliability requirements reaching packet loss probabilities as low as 10⁻⁶ to 10⁻⁴.

For UEs of any service type, and especially for URLLC UEs, it is important to have a relevant control of the uplink power to be used by the UE for sending UL signals, that is for sending signals from the UE to a network node aka base station. For this reason, the network node informs the UE of a power target called P0, i.e., a power value with which the network node wants to receive signals from the UE. The UE uses the received information of power target P0 as well as information of pathloss to determine which power level to use for transmission of the UL signals so that the network node will receive the UL signals at the power target stipulated by the network node.

In New Radio (NR), such UL power control determines the transmission power to use for Physical Uplink Shared Channel (PUSCH), Physical Uplink Control Channel (PUCCH), Sounding Reference Signals (SRS) and Physical Random Access Channel (PRACH) transmissions, among others. In the NR standard 3GPP TS 38.213 V16.5.0 Chapter 7.1, it is stated that the UE determines the PUSCH transmission power PPUSCH as

$$\\ \begin{matrix}{P}_{PUSCH} = min ( {P}_{max} , {P}_{0} + 10 log ( {2}^{{}_{} μ} \cdot M ) + α \cdot PL + {Δ}_{TF} + f ) [ dBm ] & ( 1 )\end{matrix}$$

where Pₘₐₓ is the UE configured maximum output power. The UE transmit power is also limited to a maximum of −7 dBW in the vast majority of cases. Further, P₀ is the power target, here called power spectrum density target per Physical Resource Block (PRB) and it is signaled to the UE, M is the number of PRBs that is used by the uplink transmission and μ is a Subcarrier Spacing, SCS, configuration defined in Chapter 4 of 3GPP TS 38.211 V16.5.0. Still further, a is a fractional pathloss power control fraction. When it is equal to 1, full pathloss is compensated, while it is smaller than 1, the pathloss is partly compensated by the UE transmit power. The objective is to reduce the potential generated inter-cell interference. Still further, PL is the UE estimated pathloss, Δ_{TF} a factor depending on the selected transport format, and f is a closed loop transmit power control (TPC) command that is signaled from the gNB to the UE, when closed loop power control is used.

There are generally two types of UL power control: open loop and closed loop. For closed loop power control, the network node measures signal quality such as signal to interference and noise ratio (SINR) of received signals and decides to raise or lower the UE transmit power according to a certain transmit power control (TPC) command based on measured signal quality and the P0, during the ongoing UL transmission. According to the 3GPP TS 38.213 V16.5.0 Chapter 7, TPC commands are set to step sizes of −1 dB, 0 dB, +1 dB and +3 dB, i.e. the network node selects any of the TPC commands mentioned as f in formula (1) above.

For open loop power control, after initial setup, when configuring e.g. uplink configured grant, there is no such feedback including TPC commands during the UL transmission as for closed loop power control. In other words, the correction factor f is not used in formula (1) above. The transmit open loop power of UL signals can be expressed as

$$\\ \begin{matrix}{P}_{, tx} = max ( {P}_{max} , {P}_{0} + 10 log ( {2}^{{}_{} μ} \cdot M ) + α \cdot PL + {Δ}_{TF} ) [ dBm ] & ( 2 )\end{matrix}$$

In existing open loop and closed loop power control, all UEs in a cell receives the same power target P0 from the network node, the target being a fixed value. Still further, the initial link adaptation to select UL resource allocation is based on a current SINR, which can be obtained via below equation.

$$\\ SINR = {P}_{rx} - {I}_{est}$$

where lest is the current interference estimation, which is a filtered interference level that is measured by the network node on a cell level, i.e. lest is the same for all UEs in the cell. Pᵣₓ is the estimated received power per PRB, and it can be obtained from the below equation

$$\\ {P}_{rx} = min ( {P}_{0} , {P}_{max} - 10 log ( {2}^{{}_{} μ} \cdot M ) - α \cdot PL - {Δ}_{TF} )$$

Based on the current SINR, the network node performs link adaptation to select modulation and coding scheme (MCS), Transport Block Size (TBS) and number of Physical Resource Blocks (PRBs) to transmit the required data size with a required reliability requirement (Block Error Rate (BLER) target).

### SUMMARY

It may be an object of embodiments of the invention to achieve an UL power control that is more efficient compared to prior art when it comes to at least one of UE power usage and usage of communication resources. It may be possible to achieve this object and others by using methods and network nodes as defined in the attached independent claims.

According to one aspect, a method is provided for UL power control, the method being performed by a network node of a wireless communication network. The method comprises determining, for a UE, a UE-specific SINR link adaption target (SINRLA), based on UE-specific QoS information for the UE, determining a power target (P0) for the UE, based on the UE-specific SINRLA, and on an estimated interference for UL signals at the network node, and sending information on the determined P0 to the UE, so that the UE can transmit packets in UL with a transmission power based on the determined P0.

According to another aspect, a network node is provided that is configured to operate in a wireless communication network and that is configured for UL power control. The network node comprises a processing circuitry and a memory. Said memory contains instructions executable by said processing circuitry, whereby the network node is operative for: determining, for a UE, a UE-specific SINRLA, based on UE-specific QoS-information for the UE; determining a power target (P0) for the UE, based on the UE-specific SINRLA, and on an estimated interference for UL signals at the network node, and sending information on the determined P0 to the UE, so that the UE can transmit packets in UL with a transmission power based on the determined P0.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic diagram of a wireless communication network in which the present invention may be used.

FIG. 2 is a flow chart illustrating a method performed by a network node, according to possible embodiments.

FIG. 3 is another flow chart illustrating a method performed by a network node, according to further possible embodiments.

FIG. 4 is yet another flow chart illustrating a method performed by a network node, according to yet further possible embodiments.

FIG. 5 is a block diagram illustrating a network node in more detail, according to further possible embodiments.

### DETAILED DESCRIPTION

With the new types of service categories that the UEs are classified in, the UEs may have very different QoS requirements. For example, UEs in the URLLC service category have extremely stringent requirements for latency and reliability. As in prior art all UEs get the same power target P0, a potentially high power target P0 is needed for all UEs in order to satisfy such UEs with extreme stringent URLLC requirements. In other words, other UEs that are in service categories that do not have the same stringent requirements will then be over-allocated. This leads to less efficient power usage and less efficient usage of communication resources, due to the over-allocation and the unnecessary high power target for some UEs. Moreover, even with a large power target P0, it is still possible that the worst URLLC UEs are not satisfied due to the inaccuracy of the interference estimation.

Further in prior art, all UEs in the cell have the same SINR for Link Adaptation, LA, which is not QoS differentiated. Since the estimated interference, lest, is considered for all UEs, the resultant link adaptation target will be conservative for some UEs. Therefore, the potential channel capacity is not fully utilized.

Consequently, there is a need for an UL power control that is more efficient compared to prior art when it comes to at least one of UE power usage and usage of communication resources.

This is achieved by a network node determining or defining a UE-specific Signal to Interference and Noise Link Adaptation target (SINRLA) for a UE connected to a network node, based on UE-specific QoS requirements, and based on this UE-specific SINRLA target then determining a UE-specific power target P0. The UE-specific power target is then sent by the network node to the UE so that the UE can transmit UL signals with a power that depends on the UE-specific power target P0.

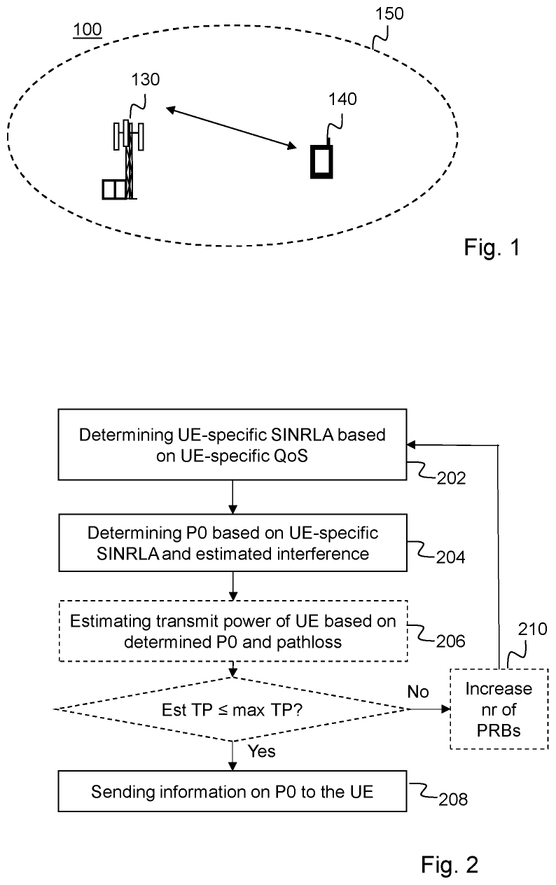

FIG. 1 shows a wireless communication network 100 in which the present invention may be used. The wireless communication network 100 comprises a radio access network (RAN) node aka network node 130 that is in, or is adapted for, wireless communication with a wireless communication device aka wireless device aka UE 140. The network node 130 provides radio access in a geographical area called a cell 150.

The wireless communication network 100 may be any kind of wireless communication network that can provide radio access to wireless devices. Example of such wireless communication networks are networks based on Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network.

The network node 130 may be any kind of network node that can provide wireless access to a wireless device 140 alone or in combination with another network node. Examples of network nodes 130 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH) and a multi-standard BS (MSR BS).

The wireless device 140 may be any type of device capable of wirelessly communicating with a network node 130 using radio signals. For example, the wireless device 140, also referred to as a User Equipment (UE), can be a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

FIG. 2, in conjunction with FIG. 1, describes a method for UL power control performed by a network node 130 of a wireless communication network 100. The method comprises determining 202, for a UE, a UE-specific SINR link adaption target (SINRLA), based on UE-specific QoS information for the UE, determining 204 a power target (P0) for the UE, based on the UE-specific SINRLA and on an estimated interference for UL signals at the network node, and sending 208 information on the determined P0 to the UE, so that the UE can transmit packets in UL with a transmission power based on the determined P0.

QoS information may also be called QoS requirements or QoS value.

QoS information may be Packet Error Rate (PER) target, Block Error Rate (BLER) target, latency budget etc. The P0 may be the power spectrum density target per Physical Resource Block, PRB. According to an embodiment, the P0 is a value of the requested received power at the network node, of UL transmissions from the UE. The UE then uses the P0 and information related to pathloss between the UE and the network node to determine with which power to transmit the packets so that they will arrive at the network node with the requested P0. The P0 can be used in open-loop power control as well as in closed-loop power control for any packets transmitted UL by the UE. The packets transmitted UL can be comprised in a Configured Grant transmission. The estimated interference for UL signals at the network node may be an estimation of the maximum interference at the network node. The estimated interference may be a general estimation of interference at the network node, or a specific interference experienced for signals sent by this particular UE.

By such a method, each UE will have an individually set SINRLA, based on individual QoS demands, i.e. each UE's individual QoS demands. Further, as the P0 is determined based on the individually set SINRLA, the UL transmitted packets can meet individual QoS demands for each UE when received at the network node. Hereby, QoS can be met for e.g. URLLC-classified UEs, that is, UEs with extreme reliability and latency requirements, and at the same time other UEs that do not have the same high QoS demands can have lower SINRLA and therefore can transmit with a lower power than the URLLC-classified UEs. As a result, UE transmit power is more efficiently used than for prior art when all UEs have the same SINRLA and therefore the same P0.

According to an embodiment, the UE-specific QoS information is packet error rate, and the UE-specific SINRLA is determined based on the packet error rate and on packet size D. Hereby, the UE-specific SINRLA follows both packet error rate (PER) and packet size so that an increase in packet size gives an increase in SINRLA and when a higher PER can be coped with, the SINRLA can be decreased.

According to another embodiment, the UE-specific SINRLA is determined based on the UE-specific QoS information, a selected number of Physical Resource Blocks, PRB, and a selected Modulation and Coding Scheme, MCS. Hereby, the UE-specific SINRLA follows number of PRBs allocated for the UL transmission and MCS selected for the transmission. An increase in number of PRBs could mean that a lower SINRLA can be selected and a less robust MCS could mean that a higher SINRLA is needed, and vice versa. However, a higher number of PRBs mean less efficient usage of transmission resources. By selecting SINRLA that is UE-specific results in a lower usage of PRBs in total at the network node as UEs with lower QoS requirements can use lower number of PRBs than UEs with higher QoS requirements.

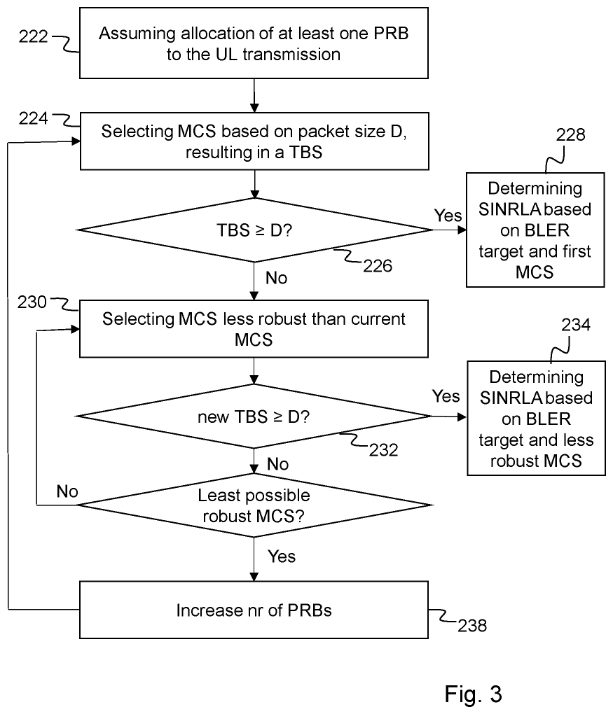

According to another embodiment, which is described in FIG. 3, the determination 202 of the UE-specific SINRLA described in FIG. 2 comprises assuming allocation 222 of a first number of PRBs to the UL transmission, selecting 224 a first MCS for coding of the packet to be transmitted, based on the assumed allocated first number of PRBs, which results in a Transport block size, TBS, and determining 226 whether the TBS is larger than or equal to a packet size D. When the TBS is larger than or equal to the packet size D, allocating the first number of PRBs and determining 228 the SINRLA based on the UE-specific QoS information and the first MCS. The allocation of the first number of PRBs may be sent to the UE in connection with the sending of the P0 or in a separate transmission. The UE-specific QoS information may be a BLER target value.

The first number of PRBs may be one PRB, or two PRBs etc. “A less robust MCS” signifies an MCS with less coding bits than the first MCS. The first MCS may be the lowest MCS, i.e. most robust MCS that can transmit packets with packet size D within the at least one PRB. Hereby, it can be tested first which number of PRBs that functions for this UE with its specific QoS requirements before the actual allocation.

According to another embodiment also shown in FIG. 3, the method further comprises, when the TBS is smaller than the packet size D, selecting 230 a second MCS that is less robust than the first MCS resulting in a second TBS, and determining 232 whether the second TBS is larger than or equal to the packet size D for the second MCS. When the second TBS is larger than or equal to the packet size D for the second MCS, allocating the first number of PRBs and determining 234 the SINRLA based on the UE-specific QoS information and the second MCS. When the TBS is still smaller than the packet size D for the second MCS, selecting an MCS that is less robust than the second MCS in steps until: either the TBS is larger than or equal to the packet size and then allocate the first number of PRBs and determine the SINRLA based on the UE-specific QoS information and on the selected MCS that resulted in the TBS becoming larger than or equal to the packet size; or a least possible robust MCS is reached and the TBS is still lower than the packet size, and then assuming allocation of a second number of PRBs that is higher than the first number of PRBs, i.e. increase 238 nr of PRBs, and selecting 224 an MCS for coding of the packet to be transmitted based on the assumed allocated second number of PRBs, which results in a second TBS and determining whether the second TBS is larger than or equal to the packet size D.

“Selecting MCS that is less robust in steps until the TBS is larger than or equal to the packet size” signifies testing with a third MCS that is less robust than the second MCS, and if this results in a TBS larger than the packet size D, the SINRLA is determined based on the third MCS. Further, if this results in a TBS that is still lower than the packet size, an even less robust MCS is selected, and so on until the TBS becomes higher than the packet size or the least robust MCS is reached. When the least robust MCS is reached and the TBS is still lower than the packet size, the number of assumed allocated PRBs is increased 238 to a second number of PRBs that is higher than the at least one PRBs. The number of assumed allocated PRBs is in an embodiment increased with one, but alternatively it is possible to increase the number of PRBs with more than one. In this embodiment, when the TBS is still lower than the packet size D, despite the assumed increase of PRB and the selected most robust MCS, a less robust MCS is selected in steps in a similar way as described above for the at least one PRBs. Further, in case an unnecessarily high number of PRBs was selected as “the at least one” PRB or as “the second number of PRB”, it may be possible to decrease the number of PRBs. For example, if it turns out that the TBS is much larger than the packet size for the most robust MCS, a lower number of PRBs may be selected.

According to yet another embodiment, which is shown in FIG. 2, the method further comprises estimating 206 a transmit power of the UE based on the determined 204 P0 and an estimation of pathloss between the UE and the network node, and when the estimated transmit power is below or equal to a maximum transmit power of the UE, perform the sending 208 of the information on the determined P0 to the UE. Hereby, the network node can determine itself whether it is possible for the UE to send with a power that is requested to reach the UE-specific P0, before it sends the P0. As a result, a quicker determination of valid P0 can be achieved as well as unnecessary signaling to the UE is avoided.

According to still another embodiment, which is shown in FIG. 2, when the estimated 206 transmit power is above the maximum transmit power of the UE, increasing 210 number of PRBs to a second number of PRBs, and determining 202 the UE-specific SINRLA based on UE-specific QoS, the increased number of PRBs and the selected MCS. In other words, when the UE cannot transmit with a power that is requested to reach the UE-specific P0, the number of PRBs are increased so that the transmission can use at least one more PRB. Then a new SINRLA is calculated based on the new number of PRBs and a lower UE-specific P0 is reached based on the new SINRLA.

According to another embodiment, when the increasing 210, 238 of the at least one allocated PRBs results in a number of PRBs exceeding a maximum number of available PRBs configured, segmenting the packets to be transmitted into a packet size smaller than the packet size D, and perform the determining of SINRLA 202, the determining of P0 204 and the sending 208 of information on P0 again but based on the packet size smaller than the packet size D. This step is needed to be taken when it is determined that the current resource allocation cannot handle the original packet size D.

According to another embodiment, a BLER target is derived from the QoS information, and the P0 is determined 204 based on the UE-specific SINRLA on the estimated maximum interference for UL signals at the network node and also on an additional backoff, the backoff being added when the BLER target is lower than a defined threshold T. The additional backoff is an extra margin, e.g. one or more extra dB that is added to the P0 to secure the transmission even for interferences that become even slightly higher than the estimated maximum interference. T is a parameter that is determined from how critical the transmission is considered. For example, whether the reliability requirement is 99,99% or 99,999% of transmissions succeeding.

According to an embodiment, the UE-specific QoS information is a UE packet delay budget, PDB, the method comprising determining a BLER target based on the PDB, and the UE-specific SINRLA is determined based on the BLER target.

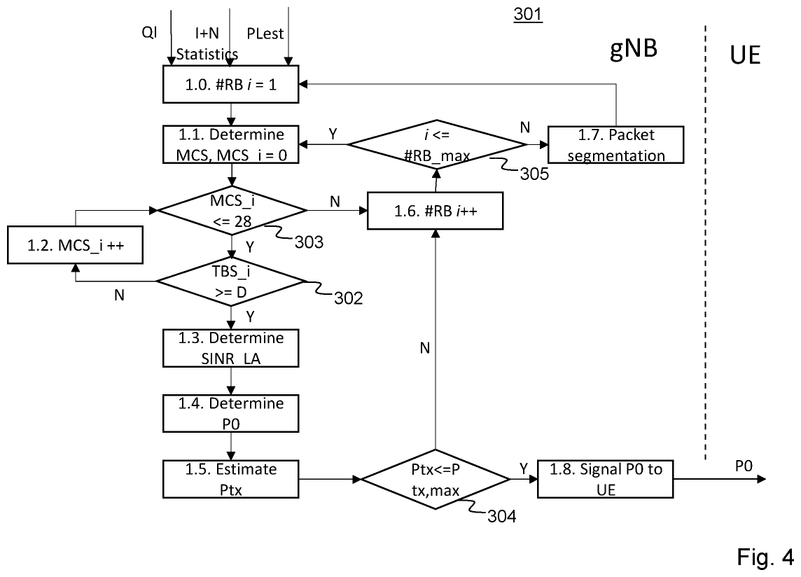

FIG. 4 describes an embodiment of determining a power target for UL transmissions in a wireless communication network, here exemplified by an NR network and an NR network node called gNodeB (gNB) 301. In this embodiment, the gNB 301 first determines the UE-specific SINR link adaptation target (SINRLA) based on UE-specific QoS information. The QoS information may be packet delay budget (PDB) and/or Packet Error Rate (PER). A target HARQ operating point i.e. BLER target may be decided based on the PDB depending on a number of transmissions supported within the PDB and on the PER. The SINRLA may be determined so that the packet size (D) will be transmitted with minimum number of packet resource blocks (PRBs) with required BLER target and preferably so that the UE is not power limited. The UE specific power target is then determined based on the UE-specific SINRLA and on a pathloss estimation for signals transmitted between the UE and the gNB, the pathloss estimation being obtained e.g. from UE power headroom report (PLₑₛₜ).

In the following, an example of a logic for achieving the above embodiment is described with reference to FIG. 4: Step 1.0, for UE_k from N UEs connected to the gNB, where k=1 to N, determine a BLERtarget_k based on PER and PDB, which may be received in a Quality of Service Indicator (QI) information. If the QI information does not have any PDB information or if PDB is long enough to support multiple retransmissions, BLERtarget_k is set to a relaxed value such as 10%, which is a conventional link adaptation target for an eMBB classified UE, then a prior art-based Open Loop Power Control (OLPC) can be selected for those UEs. In other words, all such UEs may get one and the same P0. If on the other hand, the QI information contains PDB information and the PDB support two or more number of transmissions, and there is only a single path retransmission, the BLERtarget_k can be set as a more relaxed BLERtarget than the PER. Further, a UE-specific power control is used according to embodiments of this disclosure, here called a SINR-based power control. On the other hand, if the QI information contains PDB information and the PDB information shows that only one-shot transmission can be supported, i.e. no retransmission can occur, the BLERtarget_k is set equal to PER and then the UE-specific power control according to embodiments of this disclosure is used. Further, in step 1.0, for UE_k for each UE using the SINR-based power control, assume allocation of i=1 PRB to the UL transmission.

Further, in step 1.1, determine or select an MCS based on packet size D of packets to be transmitted and on the assumed allocation of i PRBs to the UL transmission. MCS may in step 1.1 be the lowest MCS that can transmit D within i PRBs. This MCS is in FIG. 4 called MCS_i=0. The lowest MCS signifies the most robust MCS that can be selected. The selected MCS and the i PRB results in TBSi. TBSi is then compared to D in 302. If the comparison shows that TBSi is larger than or equal to D, go to step 1.3. If the comparison shows that TBSi is smaller than D, go to step 1.2.

In step 1.2, which is reached when TBSi is smaller than D, increase the MCS, i.e. select a less robust MCS than the MCS selected in step 1.1. The MCS may be selected according to MCS index table 3 as described in 3GPP TS 38.214, V16.5.0, Chapter 5. After the increase of MCS, compare in 302 the TBSi that resulted from the increased MCS. If TBSi is still smaller than D, increase the MCS in steps in 1.2 until the TBSi becomes larger than or equal to D and then go to step 1.3. If, on the other hand, TBSi is smaller than D also when the highest possible MCS has been reached, a comparison in a step 303 reveals that there is no higher MCS, and then the process proceeds with step 1.6. The highest possible MCS is the least-robust MCS to choose from. Step 303 is shown as a comparison to the value 28, which is an example of the highest possible MCS. When the increase in step 1.2 reaches 29 (or any other value that is one integer higher than the set highest possible MCS), the process proceeds with step 1.6.

In step 1.3, the SINR link adaptation target (SINRLA) is determined based on the BLERtarget_k and the MCS that resulted in TBSi being equal to or higher than D. This may be done by searching a so called BLER curve, which shows the relation between BLER and SINR for various MCS. A typical BLER curve is shown in e.g. “LDPC Code Design for eMBB”, Chapter 5, Agenda Item 8.1.4.1.2 of 3GPP TSG WG1 Meeting #88bis, Spokane, USA, Apr. 3-7, 2017. The figures here show Frame Error Rate (FER), as a function of Es/NO for different R, where Es/No is the same as Signal to Noise Ratio (SNR) and R represents code rate. R together with Quadrature Phase Shift Keying (QPSK) shown in the title of each figure makes the MCS, where QPSK represents a used modulation scheme. Further, FER is comparative with BLER. Hereby, different curves of such figures represent what BLER (FER) one can achieve with a certain SNR (comparative with SINR) for different MCSs (comparative with QPSK+R). Based on similar BLER curves, for the present invention, when having a BLER target and a selected MCS, one can find a SINR target value that can achieve this.

After determining the SINRLA in step 1.3, the process proceeds to step 1.4 where the P0 is determined as SINRLA of step 1.3+Imax, where Imax is an estimation of a maximum interference observed in the cell. In an embodiment there may also be a backoff added to determine P0, that is P0=SINRLA+backoff+Imax. The reason to add a backoff is that in some cases there could be interference larger than Imax, although with low probability since Imax comes from a long-term observation. So, in order to guarantee the QoS for extreme cases, the back-off is added. According to an embodiment, a BLER threshold T may be used as a threshold of low BLER, and if BLERtarget_k<T, for the specific UE, only then the backoff to combat interference variation after connection is used. The BLER threshold T may be set to for example 1e-5. According to an alternative, the lower the BLER target is than the BLER threshold, the higher the backoff may be set.

After determining the P0 in step 1.4, the process proceeds to an optional step 1.5 where the UE transmit power target Ptx,i, is estimated in order to determine whether the UE can transmit with a power so that P0 can be reached for the set number of PRBs, or if a maximum transmit power Ptxmax of the UE is exceeded. Consequently, in 1.5, the UE transmit power target is determined as

$$\\ Ptx , i = {P}_{0 , i} + 10 {log}_{10} ( {2}^{{}_{} μ} \cdot i ) + α \cdot {PL}_{k} + {Δ}_{TF} ,$$

See the text to formula (1) for definitions of the terms in this formula. Further, as shown in 304, the estimated UE transmit power target Ptx for the i allocated PRB is compared to the maximum transmit power target Ptxmax. If Ptx is less than or equal to Ptxmax, the process proceeds to step 1.8. If, on the other hand, Ptx is larger than Ptxmax, the process proceeds to step 1.6.

In step 1.6, which happens after a “no” from 303 or 304 of FIG. 4, that is when the highest MCS was exceeded or the Ptxmax was exceeded, the following happens: The number of PRBs that are assumed allocated is increased, probably with one, but higher numbers may also be used. Here, in the connected comparison step 305, it is checked whether the maximum number of PRBs is exceeded. If so, the process proceeds to step 1.7. If not, the process is repeated from step 1.1, but this time with the increased number of PRBs, and the steps 1.2 etc. are gone through again as described above.

In step 1.7, which happens when the maximum number of PRBs has been reached, it is then determined that the current resource allocation cannot handle this packet size. The packet then needs to be segmented into smaller sizes, that is to sizes that can be handled within Ptxmax and with a maximum number of PRBs.

Lastly in step 1.8, which happens after the P0 was determined in step 1.4 and after a possible estimation of Ptx and comparison to Ptxmax in steps 1.5 and 304, the P0 is finally set and the PRB i is allocated. The P0 is set to the UE for which this P0 was determined, that is UE,k. The P0 is then sent to UE,k via RRC signaling. Further, MCS and PRB may be sent to UE_k.

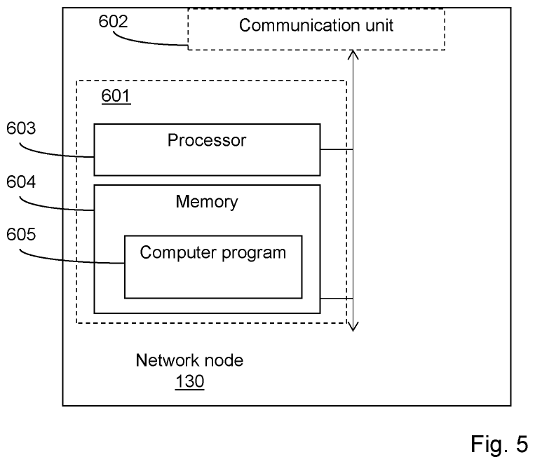

FIG. 5, in conjunction with FIG. 1, discloses a network node 130 configured to operate in a wireless communication network 100, and configured for UL power control. The network node 130 comprises a processing circuitry 603 and a memory 604. Said memory contains instructions executable by said processing circuitry, whereby the network node 130 is operative for: determining, for a UE, a UE-specific SINRLA, based on UE-specific QoS-information for the UE; determining a power target (P0) for the UE, based on the UE-specific SINRLA and on an estimated interference for UL signals at the network node, and sending information on the determined P0 to the UE, so that the UE can transmit packets in UL with a transmission power based on the determined P0.

According to an embodiment, the UE-specific QoS information is packet error rate, and the UE-specific SINRLA is determined based on the packet error rate and on packet size D.

According to an embodiment, the network node 130 is operative for determining the UE-specific SINRLA based on the UE-specific QoS information, a selected number of PRBs, and a selected MCS.

According to another embodiment, the network node 130 is operative for determining the UE-specific SINRLA by: assuming allocation of a first number of PRBs to the UL transmission; selecting a first MCS for coding of the packet to be transmitted based on the assumed allocated first number of PRBs, which results in a TBS; determining whether the TBS is larger than or equal to a packet size D, and when the TBS is larger than or equal to the packet size D, determining the UE-specific SINRLA based on the UE-specific QoS information and the first MCS.

According to yet another embodiment, the network node 130 is further operative for: when the TBS is smaller than the packet size D, selecting a second MCS that is less robust than the first MCS resulting in a second TBS, and determining whether the second TBS is larger than or equal to the packet size D for the second MCS, and when the second TBS is larger than or equal to the packet size D for the second MCS, determining the UE-specific SINRLA based on the UE-specific QoS information and the second MCS. Further, when the TBS is still smaller than the packet size D also for the second MCS, selecting an MCS that is less robust than the second MCS in steps until: either the TBS is larger than or equal to the packet size and then determine the UE-specific SINRLA based on the UE-specific QoS information and on the selected MCS that resulted in the TBS becoming larger than or equal to the packet size; or a least possible robust MCS is reached, and the TBS is still lower than the packet size, and then assuming allocation of a second number of PRBs that is higher than the first number of PRBs, and selecting an MCS for coding of the packet to be transmitted based on the assumed allocated second number of PRBs, which results in a second TBS and determining whether the second TBS is larger than or equal to the packet size D.

According to yet another embodiment, the network node 130 is further operative for estimating a transmit power of the UE based on the determined P0 and an estimation of pathloss between the UE and the network node, and when the estimated transmit power is below or equal to a maximum transmit power of the UE, perform the sending of the information on the determined P0 to the UE.

According to still another embodiment, the network node 130 is further operative for, when the estimated transmit power is above the maximum transmit power of the UE, increasing number of PRBs to a second number of PRBs, and determining the UE-specific SINRLA based on the UE-specific QoS, the increased number of PRBs and the selected MCS.

According to yet another embodiment, the network node 130 is further operative for, when the increasing of the at least one allocated PRBs results in a number of PRBs exceeding a maximum number of available PRBs configured, segmenting the packets to be transmitted into a packet size smaller than the packet size D, and performing the determining of the UE-specific SINRLA, the determining of the P0 and the sending of information on the P0 again but based on the packet size smaller than the packet size D.

According to still another embodiment, the network node 130 is further operative for deriving a BLER target from the QoS information, and determining the P0 based on the UE-specific SINRLA, on the estimated maximum interference for UL signals at the network node and also on an additional backoff, the backoff being added when the BLER target is lower than a defined threshold T.

According to another embodiment, the UE-specific QoS information is a UE packet delay budget, PDB. Further, the network node 130 is operative for determining a BLER target based on the PDB, and the UE-specific SINRLA is determined based on the BLER target.

According to other embodiments, the network node 130 may further comprise a communication unit 602, which may be considered to comprise conventional means for wireless communication with the wireless device 140, such as a transceiver for wireless transmission and reception of signals in the communication network. The communication unit 602 may also comprise conventional means for communication with other network nodes of the wireless communication network 100. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the network node 130 to perform the steps described in any of the described embodiments of the network node 130 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the network node 130 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1-22. (canceled)

23. A method for uplink (UL) power control performed by a network node of a wireless communication network, the method comprising:
determining, for a user equipment (UE), a UE-specific Signal to Interference and Noise Ratio (SINR) link adaption target (SINRLA) based on UE-specific Quality of Service (QOS) information for the UE, wherein the determination of the UE-specific SINRLA comprises:
assuming allocation of a first number of Physical Resource Blocks (PRB) to the UL transmission;
selecting a first Modulation and Coding Scheme (MCS) for coding of the packet to be transmitted, based on the assumed allocated first number of PRBs, which results in a Transport block size (TBS);
determining whether the TBS is larger than or equal to a packet size D; and
when the TBS is larger than or equal to the packet size D, determining the UE-specific SINRLA based on the UE-specific QoS information and the first MCS;
determining a power target, P0, for the UE, based on the UE-specific SINRLA, and on an estimated interference for UL signals at the network node; and
sending information on the determined P0 to the UE, so that the UE can transmit packets in UL with a transmission power based on the determined P0.

24. The method of claim 23, wherein the UE-specific QoS information is packet error rate, and the UE-specific SINRLA is determined based on the packet error rate and on packet size D.

25. The method of claim 23, wherein the method further comprises:
estimating a transmit power of the UE based on the determined P0 and an estimation of pathloss between the UE and the network node, and
when the estimated transmit power is below or equal to a maximum transmit power of the UE, perform the sending of the information on the determined P0 to the UE.

26. The method of claim 23, further comprising:
when the TBS is smaller than the packet size D, selecting a second MCS that is less robust than the first MCS resulting in a second TBS, and determining whether the second TBS is larger than or equal to the packet size D for the second MCS,
when the second TBS is larger than or equal to the packet size D for the second MCS, determining the UE-specific SINRLA based on the UE-specific QoS information and the second MCS,
when the TBS is still smaller than the packet size D for the second MCS, selecting an MCS that is less robust than the second MCS in steps until either the TBS is larger than or equal to the packet size and then determine the SINRLA based on the UE-specific QoS information and on the selected MCS that resulted in the TBS becoming larger than or equal to the packet size, or
a least possible robust MCS is reached and the TBS is still lower than the packet size, and then assuming allocation of a second number of PRBs that is higher than the first number of PRBs, and selecting an MCS for coding of the packet to be transmitted based on the assumed allocated second number of PRBs, which results in a second TBS and determining whether the second TBS is larger than or equal to the packet size D.

27. The method of claim 26, wherein when the estimated transmit power is above the maximum transmit power of the UE, increasing number of PRBs to a second number of PRBs, and determining the UE-specific SINRLA based on the UE-specific QoS, the increased number of PRBs and the selected MCS.

28. The method of claim 26, wherein when the increasing of the at least one allocated PRBs results in a number of PRBs exceeding a maximum number of available PRBs configured, segmenting the packets to be transmitted into a packet size smaller than the packet size D, and perform the determining of the UE-specific SINRLA, the determining of P0 and the sending of information on P0 again but based on the packet size smaller than the packet size D.

29. The method of claim 23, wherein a BLER target is derived from the QoS information, and wherein the P0 is determined based on the UE-specific SINRLA, on the estimated maximum interference for UL signals at the network node and also on an additional backoff, the backoff being added when the BLER target is lower than a defined threshold T.

30. The method of claim 23, wherein the UE-specific QoS information is a UE packet delay budget, PDB, the method comprising determining a BLER target based on the PDB, and wherein the UE-specific SINRLA is determined based on the BLER target.

31. A network node configured to operate in a wireless communication network, and configured for UL power control, the network node (130) comprising a processing circuitry and a memory, said memory containing instructions executable by said processing circuitry, whereby the network node (130) is operative for:
determining, for a User Equipment, UE, a UE-specific Signal to Interference and Noise Ratio (SINR) link adaption target (SINRLA) based on UE-specific Quality of Service (QOS) information for the UE, wherein determining the SINRLA comprises:
assuming allocation of a first number of Physical Resource Blocks (PRB) to the UL transmission;
selecting a first Modulation and Coding Scheme (MCS) for coding of the packet to be transmitted, based on the assumed allocated first number of PRBs, which results in a Transport block size (TBS);
determining whether the TBS is larger than or equal to a packet size D; and
when the TBS is larger than or equal to the packet size D, determining the UE-specific SINRLA based on the UE-specific QoS information and the first MCS;
determining a power target, P0, for the UE, based on the UE-specific SINRLA, and on an estimated interference for UL signals at the network node; and
sending information on the determined P0 to the UE, so that the UE can transmit packets in UL with a transmission power based on the determined P0.

32. The network node of claim 31, wherein the UE-specific QoS information is packet error rate, and the UE-specific SINRLA is determined based on the packet error rate and on packet size D.

33. The network node of claim 31, further being operative for:
estimating a transmit power of the UE based on the determined P0 and an estimation of pathloss between the UE and the network node,
when the estimated transmit power is below or equal to a maximum transmit power of the UE, perform the sending of the information on the determined P0 to the UE.

34. The network node of claim 31, further being operative for:
when the TBS is smaller than the packet size D, selecting a second MCS that is less robust than the first MCS resulting in a second TBS, and determining whether the second TBS is larger than or equal to the packet size D for the second MCS,
when the second TBS is larger than or equal to the packet size D for the second MCS, determining the UE-specific SINRLA based on the UE-specific QoS information and the second MCS,
when the TBS is still smaller than the packet size D for the second MCS, selecting an MCS that is less robust than the second MCS in steps until:
either the TBS is larger than or equal to the packet size and then determine the UE-specific SINRLA based on the UE-specific QoS information and on the selected MCS that resulted in the TBS becoming larger than or equal to the packet size,
or a least possible robust MCS is reached, and the TBS is still lower than the packet size, and then assuming allocation of a second number of PRBs that is higher than the first number of PRBs, and selecting an MCS for coding of the packet to be transmitted based on the assumed allocated second number of PRBs, which results in a second TBS and determining whether the second TBS is larger than or equal to the packet size D.

35. The network node of claim 34, further being operative for, when the estimated transmit power is above the maximum transmit power of the UE, increasing number of PRBs to a second number of PRBs, and determining the UE-specific SINRLA based on the UE-specific QoS, the increased number of PRBs and the selected MCS.

36. The network node of claim 34, further being operative for, when the increasing of the at least one allocated PRBs results in a number of PRBs exceeding a maximum number of available PRBs configured, segmenting the packets to be transmitted into a packet size smaller than the packet size D, and performing the determining of the UE-specific SINRLA, the determining of P0 and the sending of information on P0 again but based on the packet size smaller than the packet size D.

37. The network node of claim 31, further being operative for deriving a BLER target from the QoS information, and determining the P0 based on the UE-specific SINRLA, on the estimated maximum interference for UL signals at the network node and also on an additional backoff, the backoff being added when the BLER target is lower than a defined threshold T.

38. The network node of claim 31, wherein the UE-specific QoS information is a UE packet delay budget, PDB, the network node being operative for determining a BLER target based on the PDB, and wherein the UE-specific SINRLA is determined based on the BLER target.
